(19) United States
(12) Patent Application Publication
(10) Pub. No.: US 2026/0291841 A1
(43) Pub. Date: Sep. 24, 2026

(54) METHOD AND USER EQUIPMENT FOR REPORTING ASSISTANCE INFORMATION

(71) Applicant: MEDIATEK INC., Hsinchu City (TW)

(72) Inventors: Ming-Yuan CHENG, Hsinchu City (TW); Chia-Chun HSU, Hsinchu City (TW); Ting-Sheng LO, Hsinchu City (TW)

(21) Appl. No.: 18/874,240

(22) PCT Filed: Jun. 2, 2023
(86) PCT No.: PCT/CN2023/098123

§ 371 Date: Dec. 12, 2024

Related U.S. Application Data
(60) Provisional application No. 63/367,630, filed on Jul. 4, 2022.

(51) Int. Cl. H04L 43/087; H04L 43/065

(52) U.S. Cl. CPC H04L 43/087; H04L 43/065

(57) ABSTRACT

A method for reporting assistance information is provided. The method includes the following steps. A user equipment (UE) may determine assistance information based on an application, wherein the assistance information comprises jitter information. The UE may transmit the assistance information to a network node. Then, the UE may receive a configuration based on the assistance information from the network node.

### CROSS REFERENCE TO RELATED APPLICATIONS

This application claims the benefits of U.S. Provisional Application No. 63/367,630 filed on Jul. 4, 2022, the entirety of which is incorporated by reference herein.

### FIELD OF THE INVENTION

The invention generally relates to assistance information reporting technology, and more particularly, to assistance information reporting technology in which the assistance information associated with extended reality (XR) application is reported from user equipment (UE) to a network node.

### BACKGROUND OF THE INVENTION

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is 5G New Radio (NR), which is a set of enhancements to the LTE mobile standard promulgated by the Third Generation Partnership Project (3GPP). It is designed to better support mobile broadband Internet access by improving spectral efficiency, reducing costs, and improving services.

In conventional technology, when a UE performs an extended reality (XR) application, it is not specified how to report the assistance information associated with the XR application. Therefore, how to report the assistance information associated with the XR application is a topic that is worthy of discussion.

### BRIEF SUMMARY OF THE INVENTION

A method and UE for assistance information are provided to overcome the problems mentioned above.

An embodiment of the invention provides a method for reporting assistance information. The method includes the following steps: a UE may determine assistance information based on an application, wherein the assistance information comprises jitter information. The UE may transmit the assistance information to a network node. Then, the UE may receive a configuration based on the assistance information from the network node.

In some embodiments, the application comprises an extended reality (XR) application, and the assistance information is associated with the XR application.

In some embodiments, the assistance information further comprises the application types, stream types, traffic period, traffic offset, traffic size, traffic pattern, data rate, or a combination thereof.

In some embodiments, the application types may comprise virtual reality (VR), cloud gaming (CG) and augmented reality (AR).

In some embodiments, the stream types may comprise video streams, audio streams and control and pose streams.

In some embodiments, the traffic size may comprise intra-coded frame (I-frame) size and predicted frame (P-frame) size.

In some embodiments, the traffic pattern may comprise the ratio of I-frames to P-frames in a group of pictures.

In some embodiments, the jitter information comprises a minimum jitter value, a maximum jitter value and a jitter range between the minimum jitter value and the maximum jitter value. In some embodiments, the UE may receive a configured grant (CG) resource based on the jitter information from the network node. If uplink (UL) data arrives after the jitter range, the UE may use the CG resource for a transmission directly.

An embodiment of the invention provides a UE for reporting assistance information. The UE may comprise a transceiver and a processor. The processor may determine assistance information based on an application, wherein the assistance information comprises jitter information. The transceiver is coupled to the processor. The transceiver may transmit the assistance information to a network node and receiving a configuration based on the assistance information from the network node.

Other aspects and features of the invention will become apparent to those with ordinary skill in the art upon review of the following descriptions of specific embodiments of the methods, system and UE for SR transmission.

### BRIEF DESCRIPTION OF THE DRAWINGS

The invention will become more fully understood by referring to the following detailed description with reference to the accompanying drawings, wherein:

FIG. 1 is a block diagram of a wireless communications system 100 according to an embodiment of the invention.

FIG. 2 is a block diagram of a UE 200 according to an embodiment of the invention.

FIG. 3 is a schematic diagram illustrating assistance information reporting process according to an embodiment of the invention.

FIG. 4 is a schematic diagram illustrating a jitter range according to an embodiment of the invention.

FIG. 5 is a flow chart illustrating a method for reporting assistance information according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

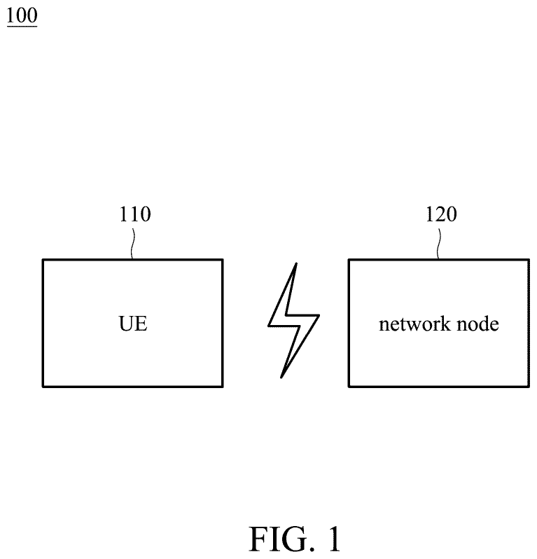

FIG. 1 is a block diagram of a wireless communications system 100 according to an embodiment of the invention. As shown in FIG. 1, the wireless communications system 100 may comprise a user equipment (UE) 110 and a network node 120. It should be noted that in order to clarify the concept of the invention, FIG. 1 presents a simplified block diagram in which only the elements relevant to the invention are shown. However, the invention should not be limited to what is shown in FIG. 1.

In the embodiments of the invention, the UE 110 may be a head-mounted display (HMD), a smartphone, Personal Data Assistance (PDA), pager, laptop computer, desktop computer, wireless handset, or any computing device that includes a wireless communications interface to communicate with network 120.

In the embodiments, the network node 120 may be a base station, a gNodeB (gNB), a NodeB (NB) an eNodeB (eNB), an access point, an access terminal, but the invention should not be limited thereto. In the embodiments, the UE 120 may communicate with the network node 130 through the fourth generation (4G) communication technology, fifth generation (5G) communication technology or 5G New Radio (NR) communication technology, but the invention should not be limited thereto.

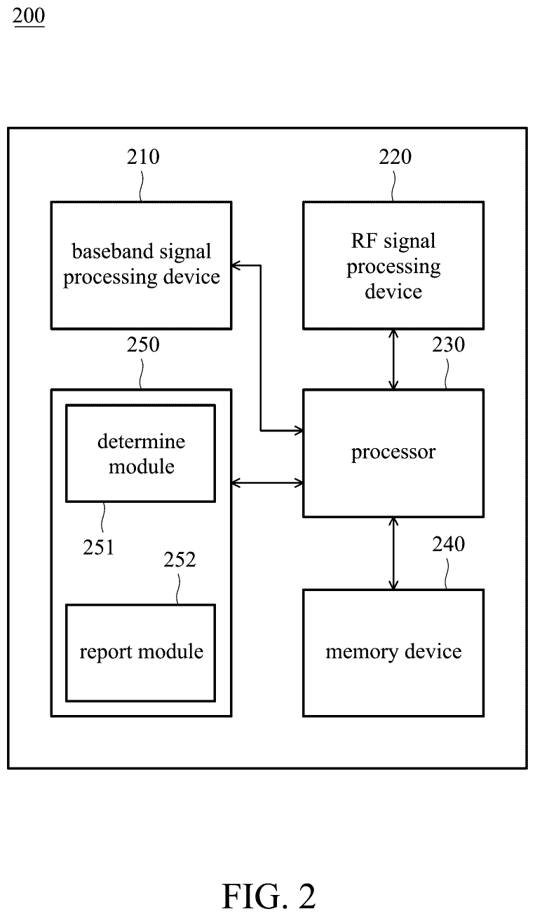

FIG. 2 is a block diagram of a UE 200 according to an embodiment of the invention. The UE 200 can be applied to the UE 110 of FIG. 1. As shown in FIG. 2, the UE 200 may comprise at least a baseband signal processing device 210, a radio frequency (RF) signal processing device 220, a processor 230, a memory device 240, and function modules and circuits 250. It should be noted that in order to clarify the concept of the invention, FIG. 2 presents a simplified block diagram in which only the elements relevant to the invention are shown. However, the invention should not be limited to what is shown in FIG. 2.

The RF signal processing device 220 may be a transceiver. The RF signal processing device 220 may comprise a plurality of antennas to receive or transmit RF signals. The RF signal processing device 220 may receive RF signals via the antennas and process the received RF signals to convert the received RF signals to baseband signals to be processed by the baseband signal processing device 210, or receive baseband signals from the baseband signal processing device 210 and convert the received baseband signals to RF signals to be transmitted to a peer communications apparatus. The RF signal processing device 220 may comprise a plurality of hardware elements to perform radio frequency conversion. For example, the RF signal processing device 220 may comprise a power amplifier, a mixer, analog-to-digital converter (ADC)/digital-to-analog converter (DAC), etc.

The baseband signal processing device 210 may further process the baseband signals to obtain information or data transmitted by the peer communications apparatus. The baseband signal processing device 210 may also comprise a plurality of hardware elements to perform baseband signal processing.

The processor 230 may control the operations of the baseband signal processing device 210, the RF signal processing device 220, the memory device 240 and the function modules and circuits 250. According to an embodiment of the invention, the processor 230 may also be arranged to execute the program codes of the software module(s) of the corresponding baseband signal processing device 210 and/or the RF signal processing device 220. The program codes accompanied by specific data in a data structure may also be referred to as a processor logic unit or a stack instance when being executed. Therefore, the processor 230 may be regarded as being comprised of a plurality of processor logic units, each for executing one or more specific functions or tasks of the corresponding software modules.

According to an embodiment of the invention, the RF signal processing device 220 and the baseband signal processing device 210 may collectively be regarded as a radio module capable of communicating with a wireless network to provide wireless communications services in compliance with a predetermined Radio Access Technology (RAT). Note that, in some embodiments of the invention, the UE 200 may be extended further to comprise more than one antenna and/or more than one radio module, and the invention should not be limited to what is shown in FIG. 2.

The memory device 240 may store the software and firmware program codes, system data, user data, etc. of the UE 200. The memory device 240 may be a volatile memory such as a Random Access Memory (RAM); a non-volatile memory such as a flash memory or Read-Only Memory (ROM); a hard disk; or any combination thereof.

The function modules and circuits 250 may comprise a determine module 251 and a report module 252. The processor 230 may execute different modules or circuits in the function modules and circuits 250 to perform embodiments of the present invention. In the embodiment of the invention, the determine module 251 may determine assistance information based on an application which the UE 200 is performing. In an example, the application may comprise an extended reality (XR) application (e.g., a virtual reality (VR) application, or an augmented reality (AR) application), and the assistance information may be associated with the XR application. The report module 252 may transmit the assistance information to the network node and receive configurations from the network node.

According to an embodiment of the invention, the baseband signal processing device 210 and the RF signal processing device 220 may be configured in a modem (MD) of the UE 200, and the processor 230 may be configured in an application processor (AP) of the UE 200. According to an embodiment of the invention, the function modules and circuits 250 may be configured in the modem or AP of the UE 200.

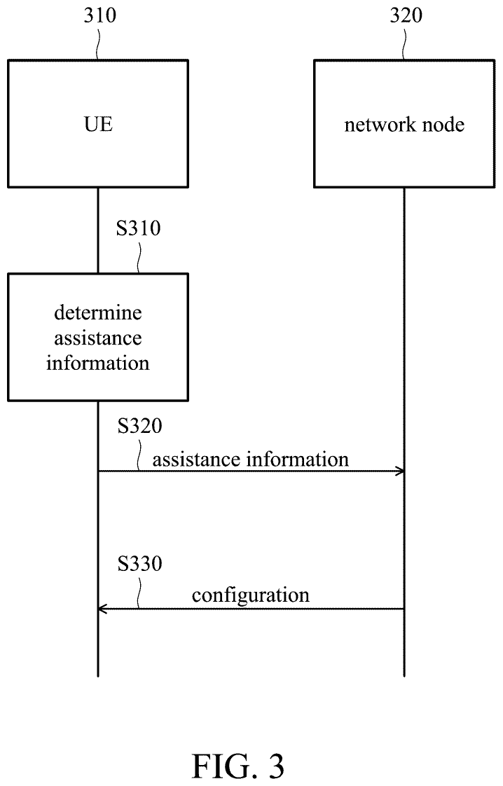

FIG. 3 is a schematic diagram illustrating assistance information reporting process according to an embodiment of the invention. In the embodiment, the UE 310 can be applied to the UE 110 of FIG. 1, and the network node 320 can be applied to network node 120 of FIG. 1. As shown in FIG. 3, in step S310, the UE 310 may determine the assistance information based on an application (e.g., a VR application, a cloud gaming (CG) application, or an AR application) which the UE 310 is performing. That is, the assistance information is associated with the application. In an embodiment, the assistance information may comprise the jitter information corresponding to the application.

In step S320, the UE 310 may transmit the assistance information to the network node 320. In step S330, the network node 320 may transmit a configuration to the UE 310 based on the assistance information.

According to an embodiment of the invention, the UE 310 may transmit the assistance information to the network node 320 through a radio resource control (RRC) signalling.

According to an embodiment of the invention, the assistance information may further comprise the application types, stream types, traffic period, traffic offset, traffic size, traffic pattern, data rate, or a combination thereof.

According to an embodiment of the invention, the application types may comprise VR, CG and AR, but the invention should not be limited thereto.

According to an embodiment of the invention, the stream types may comprise video streams, audio streams and control and pose streams. Each application type may comprise different types of streams. The video streams may be associated with the information of the traffic period, the traffic offset, the traffic size, the traffic pattern in the assistance information. The audio streams may be associated with the information of the traffic period, the traffic offset and the traffic size in the assistance information. The control and pose streams may be associated with the information of the traffic period, the traffic offset and the traffic size in the assistance information.

According to an embodiment of the invention, the traffic period may be 1/frame per second (FPS). For example, if the FPS is 60, the traffic period may 1/60 second. In an example, when the network node 320 obtains the traffic period in the assistance information from the UE 310, the network node 320 may configure a suitable discontinuous reception (DRX) for power saving based on the traffic period. In another example, when the network node 320 obtains the traffic period in the assistance information from the UE 310, the network node 320 may configure a suitable configured grant (CG) source for latency based on the traffic period.

According to an embodiment of the invention, the traffic size may comprise intra-coded frame (I-frame) size and predicted frame (P-frame) size.

According to an embodiment of the invention, the traffic pattern may comprise the ratio of I-frames to P-frames in a group of pictures of the video streams. For example, if the ratio of the I-frame pattern to the P-frame pattern is 1:7, a group of pictures may comprise 1 I-frame pattern and 7 P-frames. In addition, the traffic pattern may further comprise the number of groups of pictures of the video streams.

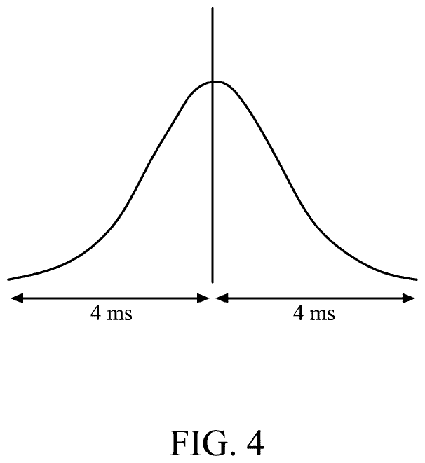

According to an embodiment of the invention, the jitter information may comprise a minimum jitter value, a maximum jitter value and a jitter range between the minimum jitter value and the maximum jitter value. FIG. 4 is a schematic diagram illustrating a jitter range according to an embodiment of the invention. As shown in FIG. 4, the jitter range may comprise 8 milliseconds (ms), but the invention should not be limited thereto.

According to an embodiment of the invention, when the network node 320 obtains the jitter information in the assistance information from the UE 310, the network node 320 may configure a configured a grant resource (CG) based on the jitter information, e.g., the network node 320 may configure the CG resource at the end of the jitter range. When the UE 310 receives the CG resource from the network node 320, the UE 310 may determine whether the UL data arrives after the jitter range. If the UL data arrives before the jitter range, the UE 310 may trigger a search request (SR). That is, the UE 310 may transmit a SR to the network node 320 to request the resource for the UL data transmission. When the network node 320 receives the SR, the network node 320 may transmit a dynamic grant (DG) to the UE 310 to configure the resource for the UL data transmission. When the UE 310 receives the DG, the UE 310 may use the configured resource to transmit the UL data and release the CG resource. If the UL data arrives after the jitter range, the UE 310 may directly use the CG resource for the UL data transmission without triggering a SR.

According to an embodiment of the invention, the process shown in FIG. 3 and the above embodiments also can be applied to a tethering transmission mechanism. In the tethering transmission mechanism, the UE 310 may have lower transmission capability (e.g. an augmented reality (AR) glasses), i.e., the UE cannot directly transmit data to the network node. Therefore, the UE 310 may transmit the assistance information to another UE with enough transmission capability (i.e., the UE can directly transmit data to the network node) through a communication link (e.g., a Wi-Fi, a bluetooth (BT), sidelink and a cable, but the invention should not be limited thereto) first. Then, the UE may transmit the assistance information of the UE 310 to the network node 320.

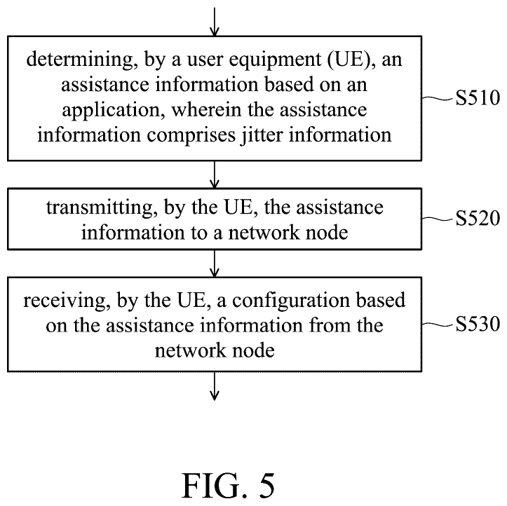

FIG. 5 is a flow chart illustrating a method for reporting assistance information according to an embodiment of the invention. The method can be applied to the wireless communications system 100. As shown in FIG. 5, in step S510, the UE 110 may determine assistance information based on an application, wherein the assistance information comprises jitter information.

In step S520, the UE 110 may transmit the assistance information to the network node 120. In step S530, the UE 110 may receive a configuration based on the assistance information from the network node 120.

According some embodiments of the invention, in the method, the application may comprise an Extended Reality (XR) application, and the assistance information is associated with the XR application.

According some embodiments of the invention, in the method, the assistance information may further comprise application types, stream types, traffic period, traffic offset, traffic size, traffic pattern, data rate, or a combination thereof.

According some embodiments of the invention, in the method, the application types may comprise virtual reality (VR), cloud gaming (CG) and augmented reality (AR).

According some embodiments of the invention, in the method, the stream types may comprise video streams, audio streams and control and pose streams.

According some embodiments of the invention, in the method, the traffic size comprises intra frame (I-frame) size and predicted frame (P-frame) size.

According some embodiments of the invention, in the method, the traffic pattern comprises the ratio of I-frames to P-frames in a group of pictures.

According some embodiments of the invention, in the method, the jitter information comprises a minimum jitter value, a maximum jitter value and a jitter range between the minimum jitter value and the maximum jitter value. In the method, the UE 110 may receive a configured grant (CG) resource based on the jitter information from the network node. In addition, in the method, the UE 110 may use the CG resource directly for a transmission if UL data arrives after the jitter range.

In the method for reporting assistance information provided in the invention, the UE will be able to provide the assistance information associated with extended reality (XR) application to the network node.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for reporting assistance information, comprising:
determining, by a user equipment (UE), an assistance information based on an application, wherein the assistance information comprises jitter information;
transmitting, by the UE, the assistance information to a network node; and
receiving, by the UE, a configuration based on the assistance information from the network node.

2. The method of claim 1, wherein the application comprises an extended reality (XR) application, and the assistance information is associated with the XR application.

3. The method of claim 1, wherein the assistance information further comprises application types, stream types, a traffic period, a traffic offset, a traffic size, a traffic pattern, a data rate, or a combination thereof.

4. The method of claim 3, wherein the application types comprise virtual reality (VR), cloud gaming (CG) and augmented reality (AR).

5. The method of claim 3, wherein the stream types comprise video streams, audio streams and control and pose streams.

6. The method of claim 3, wherein the traffic size comprises intra-coded frame (I-frame) size and predicted frame (P-frame) size.

7. The method of claim 3, wherein the traffic pattern comprises a ratio of I-frames to P-frames in a group of pictures.

8. The method of claim 1, wherein the jitter information comprises a minimum jitter value, a maximum jitter value and a jitter range between the minimum jitter value and the maximum jitter value.

9. The method of claim 8, further comprising:
receiving, by the UE, a configured grant (CG) resource based on the jitter information from the network node.

10. The system of claim 9, further comprising:
using, by the UE, the CG resource for a transmission directly if uplink (UL) data arrives after the jitter range.

11. A user equipment (UE) for reporting assistance information, comprising:
a processor, determining an assistance information based on an application, wherein the assistance information comprises jitter information; and
a transceiver, coupled to the processor, transmitting the assistance information to a network node and receiving a configuration based on the assistance information from the network node.

12. The UE of claim 11, wherein the application comprises an extended reality (XR) application, and the assistance information is associated with the XR application.

13. The UE of claim 11, wherein the assistance information further comprises application types, stream types, a traffic period, a traffic offset, a traffic size, a traffic pattern, a data rate, or a combination thereof.

14. The UE of claim 13, wherein the application types comprise virtual reality (VR), cloud gaming (CG) and augmented reality (AR).

15. The UE of claim 13, wherein the stream types comprise video streams, audio streams and control and pose streams.

16. The UE of claim 13, wherein the traffic size comprises intra-coded frame (I-frame) size and predicted frame (P-frame) size.

17. The UE of claim 13, wherein the traffic pattern comprises a ratio of I-frames to P-frames in a group of pictures.

18. The UE of claim 11, wherein the jitter information comprises a minimum jitter value, a maximum jitter value and a jitter range between the minimum jitter value and the maximum jitter value.

19. The UE of claim 18, wherein the transceiver further receives a configured grant (CG) resource based on the jitter information from the network node.

20. The UE of claim 19, wherein if uplink (UL) data arrives after the jitter range, the processor further uses the CG resource for a transmission directly.
